(19) United States
(12) Patent Application Publication
(10) Pub. No.: US 2006/0005678 A1
(43) Pub. Date: Jan. 12, 2006

(54) Table latch assembly for saws

(76) Inventors: Robert S. Gehret, Hampstead, MD (US); Mark D. Miller, Airville, PA (US)

Correspondence Address: THE BLACK & DECKER CORPORATION, 701 EAST JOPPA ROAD, TW199, TOWSON, MD, 21286, US

(21) Appl. No.: 11/175,736

(22) Filed: Jul. 6, 2005

Related U.S. Application Data
(60) Provisional application No. 60/585,947, filed on Jul. 7, 2004.

(51) Int. Cl. B23D 19/00; B26D 1/14

(52) U.S. Cl. 83/471.3

(57) ABSTRACT

A power tool has a base assembly, a table rotatably supported by the base assembly between two positions, and a saw assembly supported by the table. In the first position, the saw assembly is movable from an upper position to a lower position towards the table. In the second position, the saw assembly is underneath the table. A table latch assembly may latch the table in the first and second position. The table latch assembly may prevent movement to the second position when, in the first position, the saw assembly is in the upper position.

### CROSS-REFERENCE TO RELATED APPLICATION

The present application derives priority under 35 USC § 119(e) from U.S. Application Ser. No. 60/585,947, filed Jul. 7, 2004.

### FIELD OF THE INVENTION

This invention relates generally to a table latch assembly for a saw and more specifically to a table latch assembly for a combination table/miter saw.

### BACKGROUND OF THE INVENTION

Typical combination table/miter saws have a table that is rotatable relative to a base assembly. It is an object of the invention to provide a table latch assembly for latching the table relative to the base.

### SUMMARY OF THE INVENTION

In accordance with the present invention, an improved table assembly is employed. The power tool has a base assembly, a table rotatably supported by the base assembly between two positions, a saw assembly supported by the table, wherein in the first position the saw assembly is movable from an upper position to a lower position towards the table and in the second position, the saw assembly is underneath the table, and a table latch assembly for latching the table in the first and second position, the table latch assembly preventing movement to the second position when, in the first position, the saw assembly is in the upper position.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIG. 1 illustrates a combination table/miter saw according to the invention, whereas FIGS. 1A-1B are side views of the combination table/miter saw in the miter saw and table saw modes, respectively;

FIG. 2 is a perspective view of the table latch assembly according to the invention;

FIG. 3 is a side view of the cam plate of the table latch assembly of FIG. 2; and

FIG. 4 is a side view of the lock plate of the table latch assembly of FIG. 2.

### DETAILED DESCRIPTION

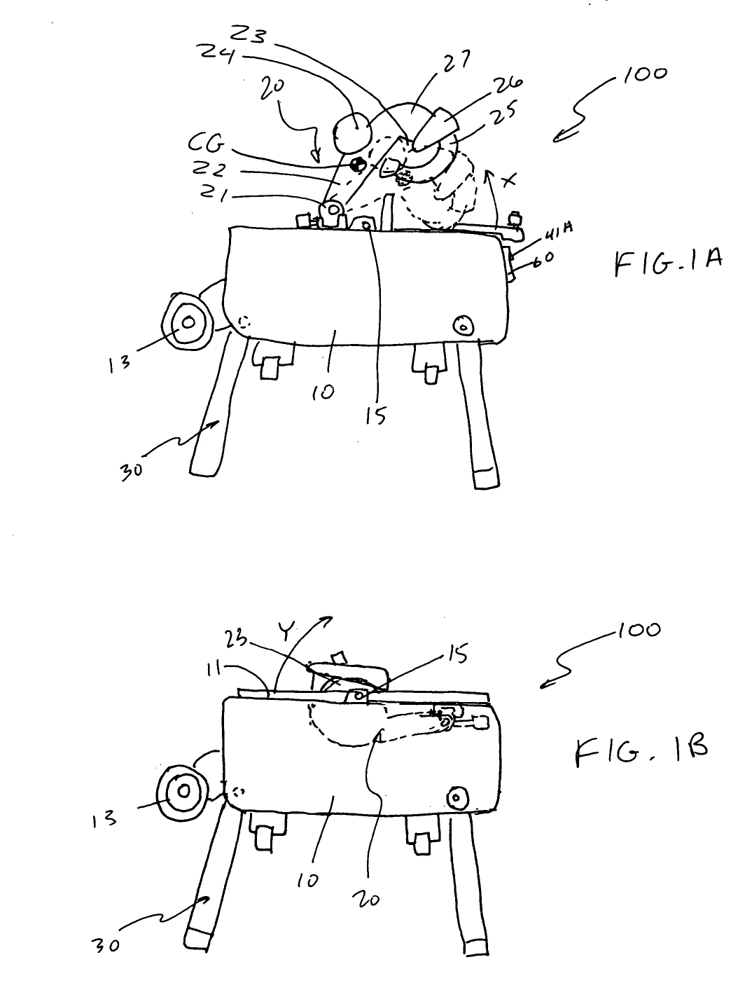

The invention is now described with reference to the accompanying figures, wherein like numerals designate like parts. Referring to FIG. 1, a combination table/miter saw 100 may include a base assembly 10, a table assembly 11 supported by base assembly 10, and a saw assembly 20 supported by the table assembly 11. Saw assembly 20 may include a trunnion 21 disposed on the table assembly 11, a pivotable arm 22 pivotably attached to trunnion 21, a motor 24 supported by the arm 22 and driving a blade 23. Arm 22 also supports upper blade guard 27, which covers an upper part of blade 23. Lower blade guard 25 is pivotally attached to upper blade guard 27. An auxiliary blade guard 26 may be pivotably connected to lower blade guard 25.

Preferably, table assembly 11 is pivotally attached to base assembly 10 via joint 15 so that, when the table assembly 11 is in the orientation of FIG. 1A, the saw assembly 20 can act as a miter saw, i.e., saw assembly 20 can be pivoted downwardly towards table assembly 11 to cut a workpiece placed on table assembly 11.

On the other hand, when table assembly 11 is rotated via joint 15 to the orientation of FIG. 1B, the saw 100 acts as a table saw, i.e., saw assembly 20 will be supported by and disposed underneath the table assembly 11. In such orientation, blade 23 extends through the table assembly 11, so that a user can dispose a workpiece on table assembly 11 and push it towards blade 23 for cutting.

Preferably, base assembly 10 has at least one wheel 13 thereon.

Base assembly 10 may also support four leg assemblies 30. Preferably leg assemblies 30 are pivotally attached to base assembly 10.

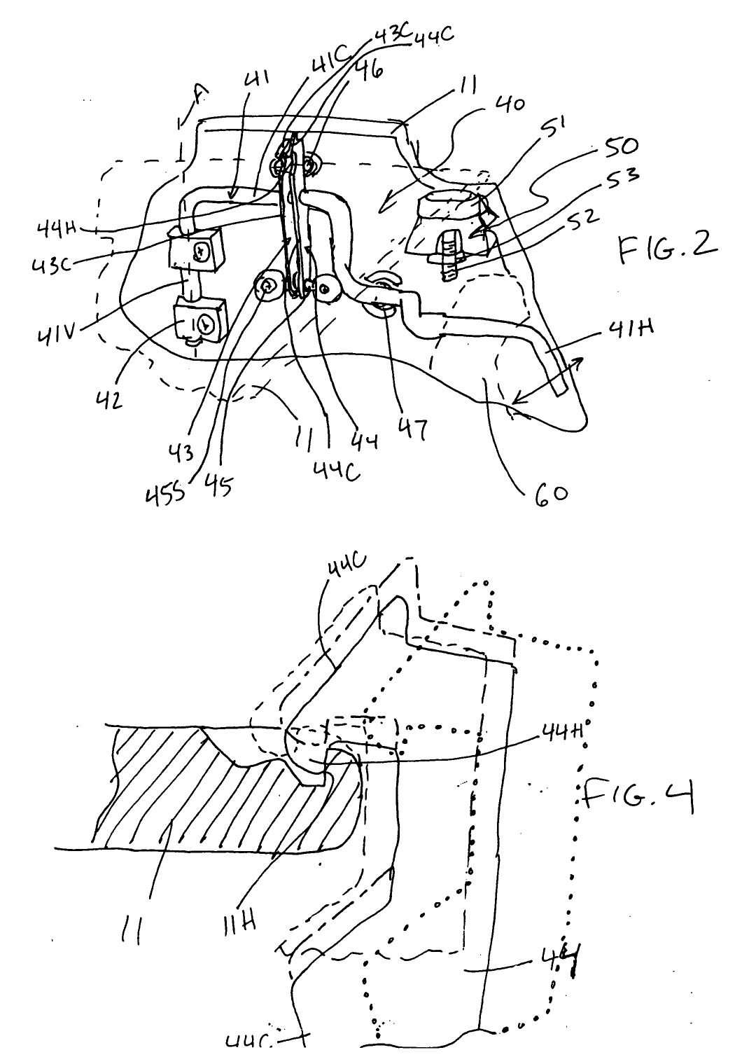

Because the saw 100 can be used as either a table saw or a miter saw, it is preferable to provide a table latch assembly 40 that facilitates the movement of table assembly 11 to switch between the table saw and miter saw modes. Referring to FIGS. 2-4, the table latch assembly 40 may include a link 41 pivotally attached to base assembly 10.

Link 41 may be sandwiched between base assembly 10 and holders 42. Preferably, link 41 has a vertical portion 41V so that link 41 can rotate about the longitudinal axis A of the vertical portion 41V. Preferably axis A is substantially vertical.

Link 41 may have a portion 41C that is connected to vertical portion 41V. Portion 41C may pivotably support a cam plate 43 and a lock plate 44. Preferably cam plate 43 and lock plate 44 are pivotally attached to base assembly 10 via a shaft 45, which may be captured unto base assembly 10 by screws 45S.

Persons skilled in the art will recognize that, due to the rotational motion of vertical portion 41V along axis A, link 41, cam plate 43 and lock plate 44 are movable towards and away from base assembly 10. Preferably springs 46 may be provided on base assembly 10 to contact cam plate 43 and/or lock plate 44 to bias link 41, cam plate 43 and lock plate 44 away from base assembly 10. Similarly, spring 47 may be provided on base assembly 10 to contact link 41 to bias link 41, cam plate 43 and lock plate 44 away from base assembly 10.

As shown in FIG. 3, cam plate 43 may have cam surfaces 43C which may contact table assembly 11. As table assembly 11 is moved between positions, such movement will push cam plate 43 towards base assembly 10. The movement of cam plate 43 in turn causes the movement of lock plate 44 and link 41 towards base assembly 10.

Referring to FIGS. 1 and 3, persons skilled in the art will recognize that saw 100 may be changed from miter saw mode (FIG. 1A) to table saw mode (FIG. 1B) by rotating table assembly 11 in the rotational direction X shown in FIG. 1A. In such motion, a side edge on the front portion of table assembly 11 may contact the second uppermost cam surface 43C shown in FIG. 3, moving lock plate 44 and link 41 towards base assembly 10. As the rotational movement of table assembly 11 approaches 180 degrees, a side edge on the originally rear portion of table assembly 11 (and now becoming the front portion of table assembly 11) contacts the lowermost cam surface 43C, as shown in FIG. 3, moving lock plate 44 and link 41 towards base assembly 10.

Similarly, saw 100 may be changed from table saw mode (FIG. 1B) to miter saw mode (FIG. 1A) by rotating table assembly 11 in the rotational direction Y shown in FIG. 1B. In such motion, the side edge on the originally rear portion and now front portion of table assembly 11 may contact the second lowermost cam surface 43C shown in FIG. 3, moving lock plate 44 and link 41 towards base assembly 10. As the rotational movement of table assembly 11 approaches 180 degrees, the side edge on the originally front portion of table assembly 11 (and now returning) contacts the uppermost cam surface 43C shown in FIG. 3, moving lock plate 44 and link 41 towards base assembly 10.

Preferably a trough 43V will be provided between the uppermost cam surfaces 43C and the lowermost cam surfaces 43C. In this manner, when table assembly 11 moves towards trough 43V (and possibly ride along the middle cam surfaces 43C), springs 46 and/or 47 may push cam plate 43, lock plate 44 and link 41 away from base assembly 10.

Preferably, table assembly 11 is not captured by trough 43V. Instead, base assembly 10 may have table stop assemblies 50. Referring to FIG. 2, table stop assembly 50 may include a pad 51, and a screw 52 attached to pad 51and threadingly engaging base assembly 10 for adjusting the height of pad 51. A nut 53 may be used to fix the location of screw 52 relative to base assembly 10.

Table stop assemblies 50 may be disposed towards the front of saw 100 to stop rotation of table assembly 11 along direction Y. Similarly, table stop assemblies 50 which may be disposed towards the rear of saw 100 will preferably stop rotation of table assembly 11 along direction X. Persons skilled in the art will recognize that table stop assemblies 50 may be arranged and table assembly 11 may be shaped so that table stop assemblies 50 only contact those portions of table assembly 11 necessary to stop rotation and to avoid contact with other portions of table assembly 11 which may prevent the full rotation between modes.

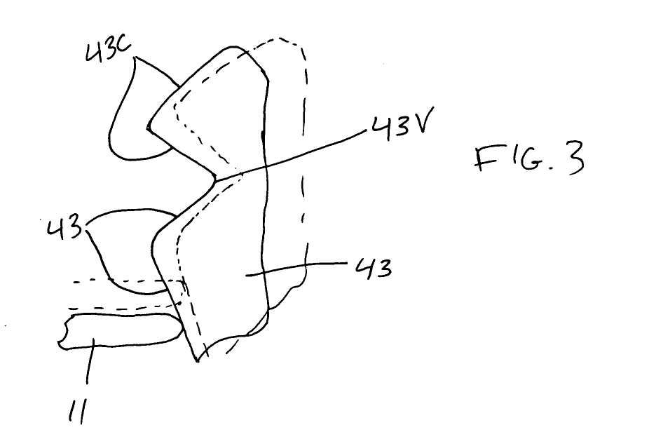

Referring to FIGS. 2 and 4, lock plate 44 is used to prevent the undesired rotation of table assembly 11. Lock plate 44 has a hook portion 44H that overlaps table assembly 11 (see position shown in broken lines in FIG. 4) to prevent it from moving in direction X unless such movement is desired. Hook portion 44H forces the user to move link 41 (and thus hook portion 44H) towards base assembly 10 in order to unlatch table assembly 11.

As shown in FIG. 1A, when saw 100 is in miter saw mode, the saw assembly 20 will preferably have its center of gravity CG behind joint 15 when saw assembly 20 is in an upper position, and in front of joint 15 when saw assembly 20 is in a lower position (shown in broken lines). Accordingly, if table assembly 11 were to be released when saw assembly 20 is in the upper position, table assembly 11 would pivot along direction.

It is desirable to prevent such rotation of table assembly 11. Table assembly 11 may thus be provided with a hook portion 11H, which is preferably below the workpiece supporting surface of table assembly 11. If the user were to move link 41 towards base assembly 10 while saw assembly 20 was in the upper position, table assembly 11 would quickly rotate, catching hook portion 44H with hook portion 11H (see position of lock plate 44 shown in solid line in FIG. 4). Such engagement would stop the rotation of table assembly 11.

To avoid such engagement, the user is preferably forced to move saw assembly 20 to the lower position and lock saw assembly 20 in such position. Because the center of gravity CG of saw assembly 20 is now in front of joint 15, table assembly 11 does not rotate when released. If anything, table assembly 11 is biased away from hook portion 44H due to the relation of center of gravity CG relative to joint 15. Persons skilled in the art will recognize that at least one table stop assembly 50 will prevent further rotation of table assembly 11 even with such bias.

In such situation, when the user moves link 41, lock plate 44 is moved from the position shown in broken lines in FIG. 4 to the position shown in dots and dashes. The user's movement of link 41 and/or the interaction of table assembly 11 with cam surface 43 may further move lock plate 44 to the position shown in dots in FIG. 4, thus completely clearing table assembly 11 and allowing the user to rotate table assembly 11.

Persons skilled in the art will recognize that lock plate 44 has two cam surfaces 44C that function in a manner similar to cam surfaces 43C to assist in the movement of cam plate 43/lock plate 44/link 41.

Referring to FIGS. 1-2, link 41 may have a handle 41H to enable the user to move link 41 (and thus lock plate 44) towards base assembly 10. Handle 41H may extend through a housing 60 supporting an on/off switch (not shown).

Persons skilled in the art may recognize other additions or alternatives to the means disclosed herein. However, all these additions and/or alterations are considered to be equivalents of the present invention.

We claim:

1. A power tool comprising:
a base assembly;
a table rotatably supported by the base assembly between two positions;
a saw assembly supported by the table, wherein in the first position the saw assembly is movable from an upper position to a lower position towards the table and in the second position, the saw assembly is underneath the table; and
a table latch assembly for latching the table in the first and second position, the table latch assembly preventing movement to the second position when, in the first position, the saw assembly is in the upper position.

2. The power tool of claim 1, wherein the table latch assembly comprises a first plate movably attached to the base assembly.

3. The power tool of claim 2, wherein the first plate is pivotably attached to the base assembly.

4. The power tool of claim 2, wherein the first plate is movable between a first position contacting the table and a second position not contacting the table.

5. The power tool of claim 4, wherein the first plate is movable between the first position and a third position where the first plate is latched unto the table.

6. The power tool of claim 4, wherein the first plate is moved between the first and second positions by a link.

7. The power tool of claim 6, wherein the link is pivotably attached to the base assembly.

8. The power tool of claim 6, further comprising a spring disposed between the base assembly and the link for biasing the first plate towards the first position.

9. The power tool of claim 6, wherein the link has a handle for moving the first plate between the first and second positions.

10. The power tool of claim 6, wherein the link extends through the first plate.

11. The power tool of claim 4, further comprising a second plate movably attached to the base assembly.

12. The power tool of claim 11, wherein the second plate is pivotably attached to the base assembly.

13. The power tool of claim 11, wherein the second plate is movable between a first position contacting the table and a second position not contacting the table.

14. The power tool of claim 11, wherein the second plate is moved between the first and second positions by the link.

15. The power tool of claim 11, wherein the second plate has a cam surface.

16. The power tool of claim 15, wherein the second plate moves at least one of the link and the first plate towards the base assembly when the table is moved along the cam surface.

17. The power tool of claim 11, wherein the link extends through the second plate.

18. The power tool of claim 1, wherein the saw assembly has a center of gravity, and the table rotates between the first and second positions about a rotational axis.

19. The power tool of claim 18, wherein the center of gravity of the saw assembly is behind the rotational axis when the saw assembly in the lower position while the table is in the first position.

20. The power tool of claim 1, wherein the table latch assembly allows movement of the table to the second position when, in the first position, the saw assembly is in the lower position.
